(19) United States
(12) Patent Application Publication
(10) Pub. No.: US 2026/0006489 A1
(43) Pub. Date: Jan. 1, 2026

(54) UE Behavior Relating to PSI-Based Packet Discarding

(71) Applicant: Apple Inc., Cupertino, CA (US)

(72) Inventors: Ping-Heng Kuo, London (GB); Ralf Rossbach, Munich (DE); Naveen Kumar R Palle Venkata, San Diego, CA (US); Peng Cheng, Beijing (CN); Zhibin Wu, Los Altos, CA (US); Haijing Hu, Los Gatos, CA (US); Yuqin Chen, Shenzhen (CN); Fangli Xu, Beijing (CN); Alexander Sirotkin, Hod Hasharon (IL)

(21) Appl. No.: 18/832,060

(22) PCT Filed: Jul. 26, 2023
(86) PCT No.: PCT/CN2023/109321

§ 371 Date: Jul. 22, 2024

(51) Int. Cl. H04W 28/06; H04L 47/2425; H04L 47/28; H04L 47/32

(52) U.S. Cl. CPC H04W 28/06; H04L 47/2433; H04L 47/28; H04L 47/32

(57) ABSTRACT

This disclosure relates to techniques for changing protocol data unit (PDU) set processing behavior upon activation or deactivation of PDU set importance (PSI)-based discarding mechanism, particularly where an indication to activate/deactivate the PSI-based discarding mechanism is received when a PDU set has been partially processed. In some scenarios, the PSI-based discarding mechanism may be applied to the remainder of the PDUs in the partially processed PDU set. In other scenarios, the PSI-based discarding mechanism may not be applied until the next PDU set. In some scenarios, the decision of whether to apply the PSI-based discarding mechanism to the remainder of the PDUs in the partially processed PDU set may be based on additional conditions, e.g., involving the processing progress of the PDU set, the importance of the PDU set, other configuration details of the data radio bearer (DRB), buffer size, etc.

### PRIORITY INFORMATION

This application is a national phase entry of PCT Application No. PCT/CN2023/109321, entitled “UE Behavior Relating to PSI-Based Packet Discarding,” filed Jul. 26, 2023, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for handling packet discarding in a wireless communication system based on packet importance.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include LTE, LTE Advanced (LTE-A), NR, HSPA, IEEE 802.11 (WLAN or Wi-Fi™), BLUETOOTH™, etc.

The ever-increasing range of features and functionality introduced in wireless communication devices also creates a continuous need for improvement in both wireless communications and in wireless communication devices. In particular, as wireless networks are expecting to handle increasing amounts of traffic, it is important to ensure that network architecture designs can effectively and efficiently handle that traffic. Accordingly, improvements in the field are desired.

### SUMMARY

Embodiments are presented herein of apparatuses, systems, and methods for handling packet discarding in a wireless communication system based on packet importance.

A method may include processing a subset of protocol data units (PDUs) of a first PDU set; receiving an indication from a wireless communication network to activate a PDU set importance (PSI)-based discarding mechanism; processing the remaining PDUs of the first PDU set without applying the PSI-based discarding mechanism; and after processing the remaining PDUs of the first PDU set, processing PDUs of a second PDU set according to the PSI-based discarding mechanism. Such a method may be performed by a UE device or one or more components thereof, such as a cellular radio of the UE device.

In some scenarios, the method may further include, after processing the second PDU set, processing a subset of PDUs of a third PDU set according to the PSI-based discarding mechanism; receiving an indication from the wireless communication network to deactivate the PSI-based discarding mechanism; and processing the remaining PDUs of the third PDU set without applying the PSI-based discarding mechanism.

A method may include processing a subset of PDUs of a first PDU set; receiving an indication to activate a PSI-based discarding mechanism; determining whether specified conditional criteria are met; in response to determining that the specified conditional criteria are met, processing the remaining PDUs of the first PDU set without applying the PSI-based discarding mechanism; and in response to determining that the specified conditional criteria have not met, processing the remaining PDUs of the first PDU set according to the PSI-based discarding mechanism.

In some scenarios, the method may further include, after processing the remaining PDUs of the first PDU set, processing PDUs of a second PDU set according to the PSI-based discarding mechanism, regardless of whether the specified conditional criteria are met.

In some scenarios, determining whether the specified conditional criteria are met may include determining whether a time remaining until expiry of a discard timer of the PDU set meets a particular threshold.

In some scenarios, determining whether the specified conditional criteria are met may include determining whether a portion of PDUs of the first PDU set that has already been processed meets a particular threshold.

In some scenarios, determining whether the specified conditional criteria are met may include determining whether the first PDU set is identified as an important PDU set.

In some scenarios, determining whether the specified conditional criteria are met may include determining whether a buffer size of a logical channel (LCH) or a LCH group (LCG) carrying the first PDU set is below a particular threshold.

In some scenarios, the PSI-based discarding mechanism may include using a first discarding timer value for PDU sets that are indicated by a PSI as important, and using a second, different discarding timer value for PDU sets that are indicated by a PSI as non-important.

In some scenarios, the PSI-based discarding mechanism may include discarding PDU sets that are indicated by a PSI as non-important, without attempting transmission.

In some scenarios, processing a PDU may include loading the PDU into a transmit buffer.

A method may include processing a subset of protocol data units (PDUs) of a first PDU set; receiving an indication from a wireless communication network to activate a PDU set importance (PSI)-based discarding mechanism; and processing the remaining PDUs of the first PDU set according to the PSI-based discarding mechanism.

In some scenarios, the PSI-based discarding mechanism may include: in response to determining that a PSI associated with the first PDU set indicates that the first PDU set is non-important, discarding PDUs of the first PDU set that are queued in a transmit buffer prior to receiving the indication; and for PDUs queued in the buffer after receiving the indication, using a first discarding timer value for PDU sets that are indicated by an associated PSI as important, and using a second, different discarding timer value for PDU sets that are indicated by an associated PSI as non-important.

In some scenarios, the PSI-based discarding mechanism may include: in response to determining that a PSI associated with the first PDU set indicates that the first PDU set is non-important, discarding the PDUs of the first PDU set; and for PDUs of a second PDU set, arriving after the first PDU set, using a first discarding timer value if the second PDU set is indicated by a corresponding PSI as important, and using a second, different discarding timer value if the second PDU set is indicated by the corresponding PSI as non-important.

In some scenarios, the PSI-based discarding mechanism may include: discarding a first PDU of the first PDU set in response to determining that a PSI associated with the first PDU set indicates that the first PDU set is non-important, and further in response to determining that a time remaining on a discard timer associated with the first PDU is below a particular threshold, wherein the threshold is greater than zero.

In some scenarios, the particular threshold may constitute a difference between a default discard timer value that is not associated with the PSI-based discarding mechanism and a discard timer value corresponding to non-important PSUs according to the PSI-based discarding mechanism.

In some scenarios, the method may further include, in response to determining that a PSI associated with the first PDU set indicates that the first PDU set is important, using a discarding timer value that is specified for use with important PDU sets according to the PSI-based discarding mechanism when processing PDUs of the first PDU set that are queued after receiving the indication to activate the PSI-based discarding mechanism.

In some scenarios, the method may further include, in response to determining that a PSI associated with the first PDU set indicates that the first PDU set is important, using a discarding timer value that is not associated with the PSI-based discarding mechanism when processing PDUs of the first PDU set that are queued after receiving the indication to activate the PSI-based discarding mechanism.

A device may include one or more processors configured to perform steps of the preceding methods.

A non-transitory computer-readable storage medium may store software instructions, which, when executed by one or more processors, cause a wireless communication device to perform the steps of any of the preceding methods.

Note that the techniques described herein may be implemented in and/or used with a number of different types of devices, including but not limited to radio access network elements such as base stations, core network elements, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example (and simplified) wireless communication system, according to some embodiments;

FIG. 2 illustrates an example base station in communication with an example wireless user equipment (UE) device, according to some embodiments;

FIG. 3 illustrates an example block diagram of a UE, according to some embodiments;

FIG. 4 illustrates an example block diagram of a base station, according to some embodiments;

FIG. 5 illustrates an example block diagram of a network element, according to some embodiments;

FIG. 6 illustrates an example of two PDU sets, according to some embodiments;

FIG. 7 illustrates an example time flow in which signaling for a PSI-based packet discarding mechanism is received while a UE is processing a Protocol Data Unit (PDU) set, according to some embodiments;

FIG. 8 illustrates a flow chart of a method for activating a PDU Set Importance (PSI)-based discarding mechanism via inter-PDU set behavior, according to some embodiments;

FIG. 9 illustrates a flow chart of a method for deactivating a PSI-based discarding mechanism via inter-PDU set behavior, according to some embodiments;

FIG. 10 illustrates a flow chart of a method for activating a PSI-based discarding mechanism via intra-PDU set behavior, according to some embodiments; and

FIG. 11 illustrates a flow chart of a method for deactivating a PSI-based discarding mechanism via intra-PDU set behavior, according to some embodiments; and

FIG. 12 illustrates a flow chart of a method for activating a PSI-based discarding mechanism with conditional behavior criteria, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
BS: Base Station
DRB: Data Radio Bearer
LTE: Long Term Evolution
NR: New Radio
PDU: Protocol Data Unit
PSI: PDU Set Importance
PSIHI: PDU Set Integrity Handling Indication
RAT: Radio Access Technology
RF: Radio Frequency
RX: Reception/Receive
TRP: Transmission-Reception-Point
TX: Transmission/Transmit
UE: User Equipment
XR: Extended Reality

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well as any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

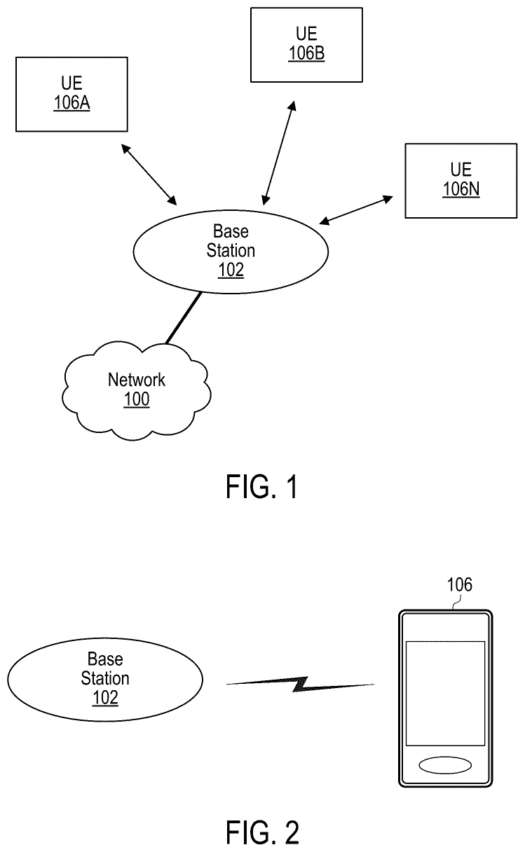

### FIGS. 1 and 2—Example Communication System

FIG. 1 illustrates an example (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the example wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. In some embodiments, it may be possible that the base station 102 includes 3GPP 6^{th} generation (6G) radio access network (RAN) node functionality. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

Note that, at least in some 3GPP contexts, base station functionality can be split, for example between any or all of centralized units (CUs), distributed units (DUs), and radio units (RUs). The illustrated base station 102 may support the functionality of any or all of a CU, a DU, or a RU, in such a network deployment context, at least according to some embodiments. In some instances, the base station 102 may be configured to act as an integrated access and backhaul (IAB) donor (e.g., including IAB donor CU and/or IAB donor DU functionality). In some instances, the base station 102 may be configured to act as an IAB node (e.g., including IAB mobile termination (MT) and IAB-DU functionality). Other implementations are also possible.

The base station 102 and the user devices may be configured to communicate over the transmission medium using any of various radio access technologies (RATs), also referred to as wireless communication technologies, or telecommunication standards, such as LTE, LTE-Advanced (LTE-A), LAA/LTE-U, 5G NR, Wi-Fi, etc. In some embodiments, at least some 3GPP 6G based communication techniques may be used to communicate over the transmission medium.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for handling traffic congestion in a wireless communication system based on packet importance, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an example user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of LTE, LTE-A, 5G NR, Wi-Fi, BLUETOOTH™, or GNSS. In some embodiments, UE 106 may be capable of operating as a 3GPP 6G wireless device, or may potentially be capable of performing at least some 3GPP 6G based communication techniques. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or NR, and separate radios for communicating using each of Wi-Fi and BLUETOOTH™. Other configurations are also possible.

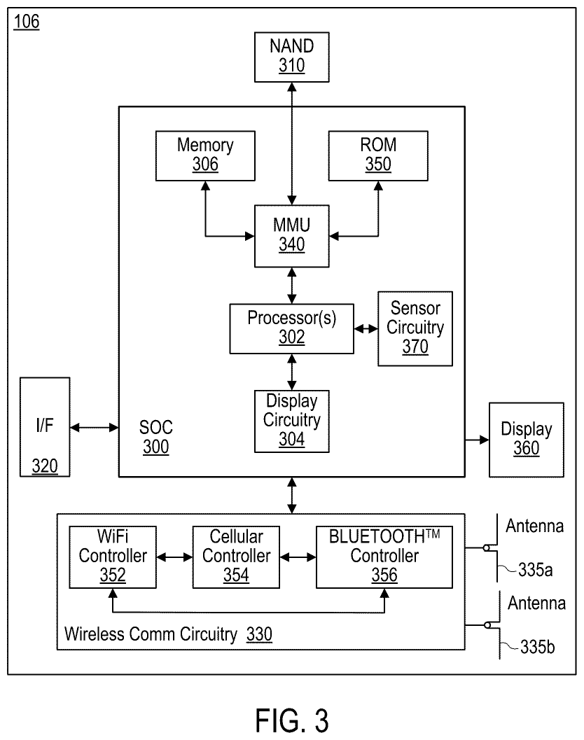

### FIG. 3—Block Diagram of an Example UE Device

FIG. 3 illustrates a block diagram of an example UE 106, according to some embodiments. As shown, the UE 106 may include a system on chip (SOC) 300, which may include portions for various purposes. Some or all of the various illustrated components (and/or other device components not illustrated, e.g., in variations and alternative arrangements) may be “communicatively coupled” or “operatively coupled,” which terms may be taken herein to mean components that can communicate, directly or indirectly, when the device is in operation.

As shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry (e.g., radio) 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, BLUETOOTH™, Wi-Fi, GPS, etc.). In some embodiments, UE 106 may be capable of operating as a 3GPP 6G wireless device, or may potentially be capable of performing at least some 3GPP 6G based communication techniques. The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of wireless communication circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform techniques for handling traffic congestion in a wireless communication system based on packet importance, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for handling traffic congestion in a wireless communication system based on packet importance according to various embodiments disclosed herein. Processor(s) 302 may also implement various other applications and/or end-user applications running on UE 106.

In some embodiments, wireless communication circuitry 330 may include separate controllers dedicated to controlling communications for various respective RAT standards. For example, as shown in FIG. 3, wireless communication circuitry 330 may include a Wi-Fi controller 352, a cellular controller (e.g., LTE and/or NR controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). While three separate controllers are illustrated within wireless communication circuitry 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

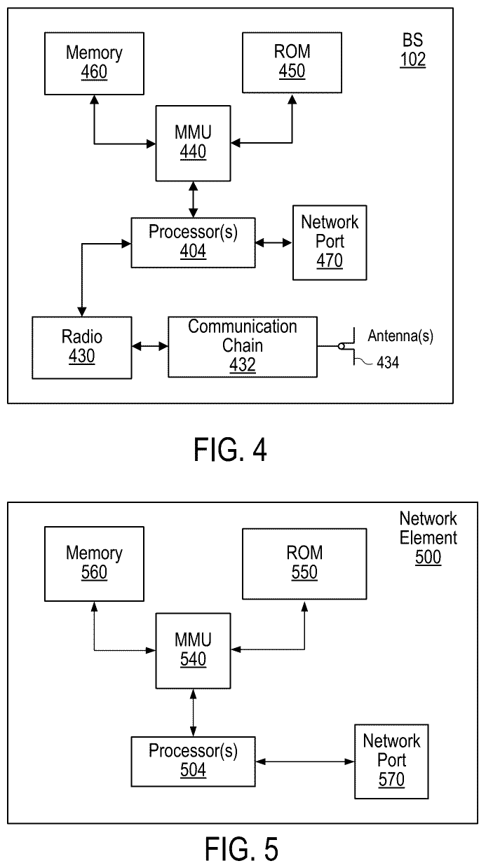

### FIG. 4—Block Diagram of an Example Base Station

FIG. 4 illustrates a block diagram of an example base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs. In some embodiments, base station 102 may be capable of operating as a 3GPP 6G radio access network node, or may potentially be capable of performing at least some 3GPP 6G based communication techniques.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### FIG. 5—Example Block Diagram of a Network Element

FIG. 5 illustrates an example block diagram of a network element 500, according to some embodiments. According to some embodiments, the network element 500 may implement one or more logical functions/entities of a cellular core network, such as a mobility management entity (MME), serving gateway (S-GW), access and management function (AMF), session management function (SMF), etc. In some embodiments, network element 500 may be capable of operating as a 3GPP 6G network node or may potentially be capable of performing at least some 3GPP 6G based communication techniques. It is noted that the network element 500 of FIG. 5 is merely one example of a possible network element 500. As shown, the core network element 500 may include processor(s) 504 which may execute program instructions for the core network element 500. The processor(s) 504 may also be coupled to memory management unit (MMU) 540, which may be configured to receive addresses from the processor(s) 504 and translate those addresses to locations in memory (e.g., memory 560 and read only memory (ROM) 550) or to other circuits or devices.

The network element 500 may include at least one network port 570. The network port 570 may be configured to couple to one or more radio access network elements and/or other cellular network entities and/or devices. The network element 500 may communicate with radio access network elements (e.g., eNBs/gNBs/etc.) and/or other network entities/devices by means of any of various communication protocols and/or interfaces.

As described further subsequently herein, the network element 500 may include hardware and software components for implementing and/or supporting implementation of features described herein. The processor(s) 504 of the core network element 500 may be configured to implement or support implementation of part or all of the methods described herein, e.g., by executing program instructions stored on a memory medium (e.g., a non-transitory computer-readable memory medium). Alternatively, the processor 504 may be configured as a programmable hardware element, such as an FPGA (Field Programmable Gate Array), or as an ASIC (Application Specific Integrated Circuit), or a combination thereof.

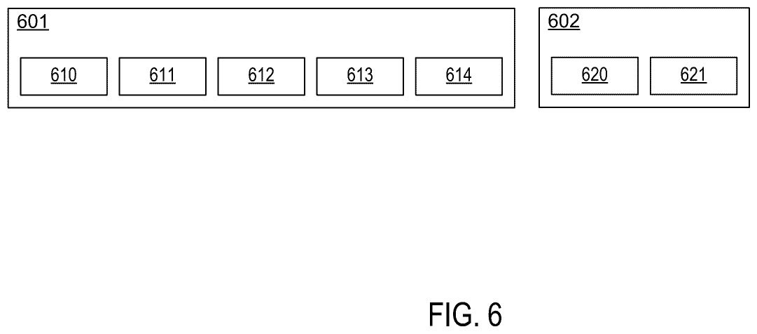

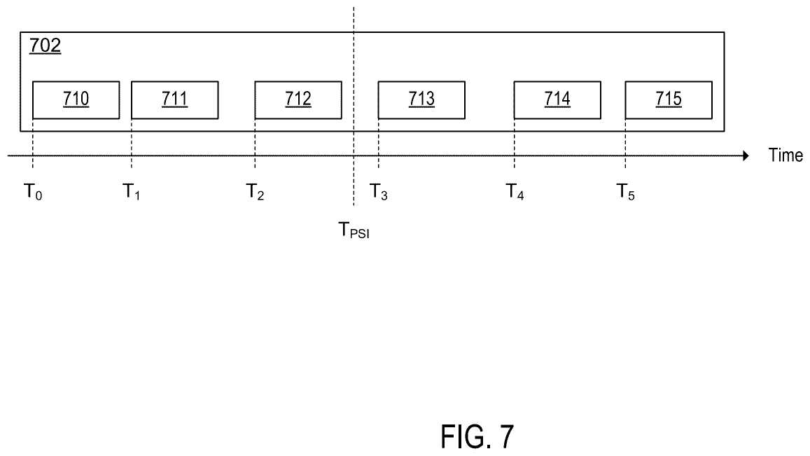

### FIGS. 6-7—PSI-Based Packet Discarding

Some communication services, such as XR, can operate on a protocol data unit (PDU) set which comprises multiple packets (e.g., IP packets). As defined in 3GPP TS 23.501, a PDU set may be defined as one or more PDUs carrying the payload of one unit of information generated at the application level, such as frame(s), video slice(s), etc., for particular services, such as XR services. A PDU Set may be associated with the following information: a PDU Set Sequence Number; an indication of the end PDU of the PDU set; a PDU sequence number within a PDU set; a PDU set size in bytes; and/or a PDU set importance (PSI), which identifies the relative importance of a PDU Set compared to other PDU sets within the same quality of service (QoS) flow. In some scenarios, this information may be carried in a header (or sub-header) of the PDU set. In some scenarios, portions of this information (e.g., information pertaining to the entire PDU set, such as the PDU Set Sequence Number, PSI, etc.) may be carried in a header of the PDU set, while other portions (e.g., information pertaining to a specific packet, such as the PDU sequence number within the PDU set) may be carried in a header of the corresponding packet. Other configurations are also envisioned. Identifying PDU set information of a PDU set may be performed in any of numerous ways, and may be implemented differently in different UEs.

FIG. 6 illustrates an example of two PDU sets, according to some embodiments. As illustrated, a first PDU set 601 includes packets 610-614. The packets 610-614 of the first PDU set 601 carry the payload of one unit of information generated at the application level, such as a first XR frame. A second PDU set 602 includes packets 620-621, which carry another unit of information generated at the application level, such as a second XR frame. PDU sets 601 and 602 may be transmitted by a UE, such as the UE 106, e.g., to a base station, such as the BS 102.

In some scenarios, the PSI may be used for PDU set-level packet discarding, e.g., in the presence of congestion. For example, the network (e.g., via the BS 102) may indicate to the UE 106 to apply a PSI-based discard mechanism (e.g., for XR services and/or other applicable services) via dedicated signaling.

The UE may classify a PDU set as an “important PDU set” or as a “non-important PDU set” based on the PSI of a PDU set. For example, PDU set having PSI meeting (or exceeding) a threshold value may be considered to be important PDU sets, while PDU sets having PSI not meeting (or not exceeding) the threshold value may be considered to be non-important PDU sets. In some scenarios, the UE may, by default, not differentiate PDU sets with high importance or low importance, as indicated in the PSI. However, in some scenarios, the network may send a dedicated signal to instruct the UE to initiate/activate a PSI-based discarding mechanism, e.g., in response to detecting uplink (UL) congestion that is considered severe. Such a PSI-based discarding mechanism may take various forms.

As a first example, the UE may apply different discarding timer values to important PDU sets and non-important PDU sets. Such discarding timer values may specify a time limit for transmitting the corresponding PDU. Specifically, a discarding timer may begin counting down from a specified discarding timer value when a PDU arrives. The UE may discard the PDU if the timer expires before the UE has successfully transmitted the PDU. When the PSI-based discarding mechanism is not applied, the UE may utilize a default discarding timer value (that is not associated with the PSI-based discarding mechanism). However, when the PSI-based discarding mechanism is applied, the UE may apply a first discarding timer value to each PDU in an important PDU set and a second, different discarding timer value to each PDU in a non-important PDU set. For example, the second discarding timer value may be shorter than the first, such that less resources are allocated to attempting to transmit non-important PDUs. In various scenarios, the first discarding timer value (associated with important PDU sets) may be equal to, longer than, or shorter than the default discarding timer value. In some scenarios. the entire PDU set may be discarded when the timer associated with one of the PDUs of the PDU set expires.

As another example, the UE may continue to transmit important PDU sets as usual, but may directly (e.g., automatically or immediately, without attempting to transmit) discard non-important PDU sets. In some scenarios, if UL congestion becomes less severe, the network may send a dedicated signal to instruct the UE to terminate/deactivate the PSI-based discarding mechanism.

Dedicated signaling from the network for activating/deactivating the PSI-based discarding mechanism might be carried in an RRC message, a PDCP control PDU, a MAC CE, or other appropriate messaging mechanism. In some scenarios, the signaling may apply to a data radio bearer (DRB), such that the PSI-based discarding mechanism may be activated/deactivated for all PDU sets on the DRB. In some scenarios, the signaling may apply to a QoS flow, such that the PSI-based discarding mechanism may be activated/deactivated for all PDU sets on the QoS flow. In these scenarios, the network may determine or select the DRB or the QoS flow where the PSI-based discarding mechanism should be activated/deactivated based, e.g., on the associated QoS flow priority level. For example, the network may activate the PSI-based discarding mechanism for DRB(s) corresponding to QoS flows with lower priority, but not for DRB(s) corresponding to QoS flows with higher priority. In some scenarios, the signaling may apply to all PDU sets handled by the UE (e.g., all DRBs and/or all QoS flows handled by the UE). In some scenarios, the signaling to activate/deactivate the PSI-based discarding mechanism may constitute a single bit, or as a single bit per DRB. In other scenarios, a different signaling arrangement may be used.

In some scenarios, the UE may receive signaling indicating that the PSI-based packet discarding mechanism should be activated or deactivated while the UE is processing a PDU set (e.g., at least one packet of the PDU set has already been processed, while at least one other packet of the same PDU set has not yet arrived in the transmit buffer). FIG. 7 illustrates such an example.

As illustrated in FIG. 7, a UE, such as the UE 106, may be configured to transmit an UL PDU set 702, consisting of a plurality of packets 710-715. The arrival times of the packets 710-715 at a transmit buffer (e.g., a L2 buffer) of the UE 106 are illustrated as T₀-T₅ as time progresses from left to right. At time T_{PSI}, the UE 106 may receive signaling from a base station, such as the BS 102, indicating that the UE should activate or deactivate a PSI-based discarding mechanism. It may be noted that T_{PSI} falls between T₂ and T₃, meaning that packets 710, 711, and 712 have arrived at the transmit buffer, but packets 713, 714, and 715 have not.

In other scenarios, T₀-T₅ may instead represent times at which the corresponding packets are transmitted by the UE 106, or times at which processing of the corresponding packets is completed.

In the scenario of FIG. 7, in which the UE 106 receives an indication to activate/deactivate a PSI-based discarding mechanism after having partially processed the PDU set 702, the UE may be configured to react to the indication in any of various ways, e.g., as discussed in any of the following examples.

In addition, in some scenarios, a traffic flow corresponding to a DRB may have a requirement based on a PDU Set Integrity Handling Indication (PSIHI), which indicates whether the application layer needs (e.g., requires, requests) every PDU of the current PDU set on the traffic flow. If the PSIHI indicates that the application layer does need every PDU of the current PDU set, then the UE may be configured to discard the whole PDU set on the DRB when one of its PDUs is lost/discarded. If the PSIHI instead indicates that the application layer does not need every PDU of the current PDU set, then the UE may be configured to attempt to transmit subsequent packets of the PDU set on the DRB after one of its PDUs is lost/discarded.

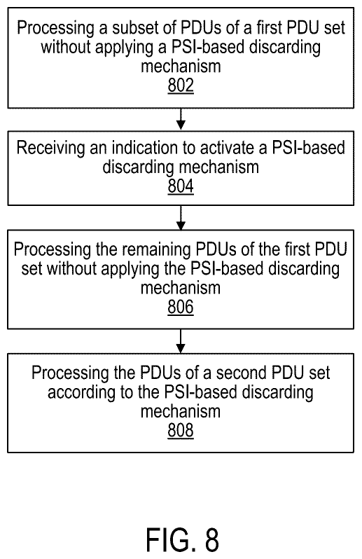

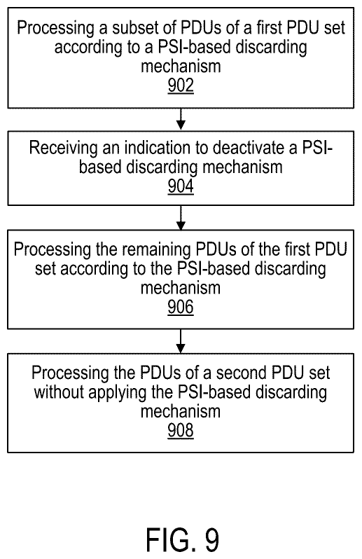

### FIGS. 8-9—Inter-PDU Set Behavior Switching

On some occasions, the UE may receive an indication to activate/enable a PSI-based discarding mechanism for a DRB when the UE has already started processing some (but not all) PDUs of a PDU set on the DRB. In some scenarios, the UE may activate the PSI-based discarding mechanism in an inter-PDU set manner. In such scenarios, the UE may not apply PSI-based discarding mechanism (e.g., does not process the network indication) on the remaining PDUs of the current PDU set. Instead, the UE may start to apply the PSI-based discarding mechanism on the next PDU set.

For example, if the PSI-based discarding mechanism includes using different discard timer values for important and non-important PDU sets, then the UE may still use the default discard timer values for the remaining PDUs of the current PDU set, regardless of the PDU set importance. However, for the next PDU set, the UE may determine the discard timer value based on the PDU set importance.

As another example, if the PSI-based discarding mechanism includes directly discarding non-important PDU sets, the UE may not directly discard the remaining PDUs of the current PDU set, even if it is a non-important PDU set. However, for the next PDU set, the UE may discard all the PDUs directly if the next PDU set is considered non-important.

FIG. 8 illustrates a flow chart of a method for activating a PSI-based discarding mechanism via inter-PDU set behavior, consistent with the preceding disclosure, according to some embodiments. The method may be performed by a UE, such as the UE 106, or by one or more components thereof, such as by the processor(s) 302 and/or the wireless communication circuitry 330 (e.g., by a baseband processor of the wireless communication circuitry 330 or of the cellular controller 354). It should be understood that the method of FIG. 8 may include additional elements beyond those shown.

As illustrated in FIG. 8, the UE 106 may, at 802, process a subset of the PDUs of a first PDU set. Specifically, the UE 106 may, at this point, have processed (e.g., processed at least to the point of placing into a transmit buffer) some, but not all, of the PDUs of the first PDU set. The UE 106 may have processed the subset of the PDUs without a PSI-based discarding mechanism.

At 804, the UE 106 may receive an indication to activate a PSI-based discarding mechanism. For example, the indication may be included in dedicated signaling from a wireless communication network with which the UE 106 is communicating. The signaling may be transmitted by a base station of the network, such as the base station 102. The signaling might be carried in an RRC message, a PDCP control PDU, a MAC CE, or other appropriate signal.

At 806, the UE 106 may process the remaining PDUs of the first PDU set without applying the PSI-based discarding mechanism. For example, the UE 106 may process the remaining PDUs in substantially the same manner as the previously processed subset of PDUs.

At 808, after processing the remaining PDUs of the first PDU set, the UE 106 may process the PDUs of a second PDU set according to the PSI-based discarding mechanism. Specifically, the UE 106 may activate the PSI-based discarding mechanism after completing the processing of the first PDU set, but before beginning processing of the second PDU set.

Similarly, on some occasions, the UE may receive an indication to deactivate/disable a PSI-based discarding mechanism for a DRB when the UE has already started processing some (but not all) PDUs of a PDU set on this DRB. In some scenarios, the UE may deactivate the PSI-based discarding mechanism in an inter-PDU set manner. In such scenarios, the UE may continue to use the PSI-based discarding mechanism on the remaining PDUs of the current PDU set, and may deactivate the PSI-based discarding mechanism prior to processing the next PDU set.

For example, if the PSI-based discarding mechanism includes using different discard timer values for important and non-important PDU sets, then the UE may still use the discard timer value corresponding to the importance level of the PDU set while processing the remainder of the current PDU set. However, for the next PDU set, the UE may apply the default discard timer value regardless of the PDU set importance.

As another example, if the PSI-based discarding mechanism includes directly discarding non-important PDU sets, the UE may directly discard the remaining PDUs of the current PDU set if it is a non-important PDU set. However, for the next PDU set, the UE may not discard all the PDUs directly, even if the next PDU set is considered non-important.

FIG. 9 illustrates a flow chart of a method for deactivating a PSI-based discarding mechanism via inter-PDU set behavior, consistent with the preceding disclosure, according to some embodiments. The method may be performed by a UE, such as the UE 106, or by one or more components thereof, such as by the processor(s) 302 and/or the wireless communication circuitry 330 (e.g., by a baseband processor of the wireless communication circuitry 330 or of the cellular controller 354). It should be understood that the method of FIG. 9 may include additional elements beyond those shown.

As illustrated in FIG. 9, the UE 106 may, at 902, process a subset of the PDUs of a first PDU set. Specifically, the UE 106 may, at this point, have processed (e.g., processed at least to the point of placing into a transmit buffer) some, but not all, of the PDUs of the first PDU set. The UE 106 may have processed the subset of the PDUs according to a PSI-based discarding mechanism, such as any of the mechanisms disclosed herein.

At 904, the UE 106 may receive an indication to deactivate a PSI-based discarding mechanism. For example, the indication may be included in dedicated signaling from a wireless communication network with which the UE 106 is communicating. The signaling may be transmitted by a base station of the network, such as the base station 102. The signaling might be carried in an RRC message, a PDCP control PDU, a MAC CE, or other appropriate signal.

At 906, the UE 106 may process the remaining PDUs of the first PDU set according to the PSI-based discarding mechanism. For example, the UE 106 may process the remaining PDUs in substantially the same manner as the previously processed subset of PDUs.

At 908, after processing the remaining PDUs of the first PDU set, the UE 106 may process the PDUs of a second PDU set without applying the PSI-based discarding mechanism. Specifically, the UE 106 may deactivate the PSI-based discarding mechanism after completing the processing of the first PDU set, but before beginning processing of the second PDU set.

Apart from activation/deactivation of the PSI-based discarding mechanism, this same inter-PDU set behavior may, in some scenarios, be applied when the Packet Data Convergence Protocol (PDCP) is re-configured (e.g., when a discard timer value is re-configured via RRC) while the UE is in the midst of processing a PDU set. For example, the UE may begin applying the new configuration in the next PDU set.

It may be observed that one example means of establishing the disclosed inter-PDU set behavior may be to define a rule requiring that the discard timer value of every PDU in a PDU set should be identical, and cannot be changed mid-PDU set, even if the UE receives an instruction to change the PDCP discard timer value for the applicable DRB (e.g., wherein the instruction may be received either as activation/deactivation signaling for the PSI-based discard mechanism, or as RRC-reconfiguration that changes discard timer value(s) of the DRB).

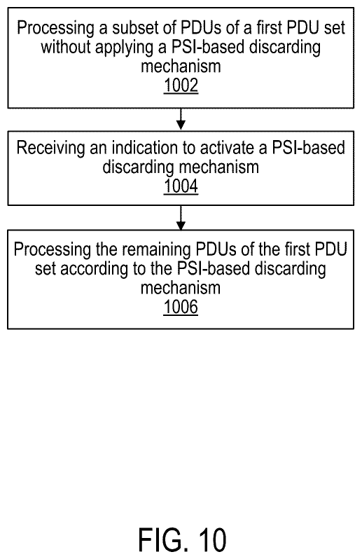

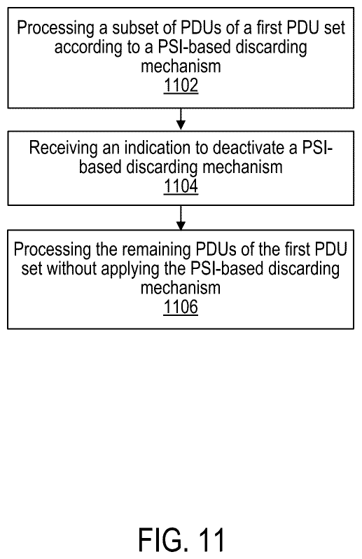

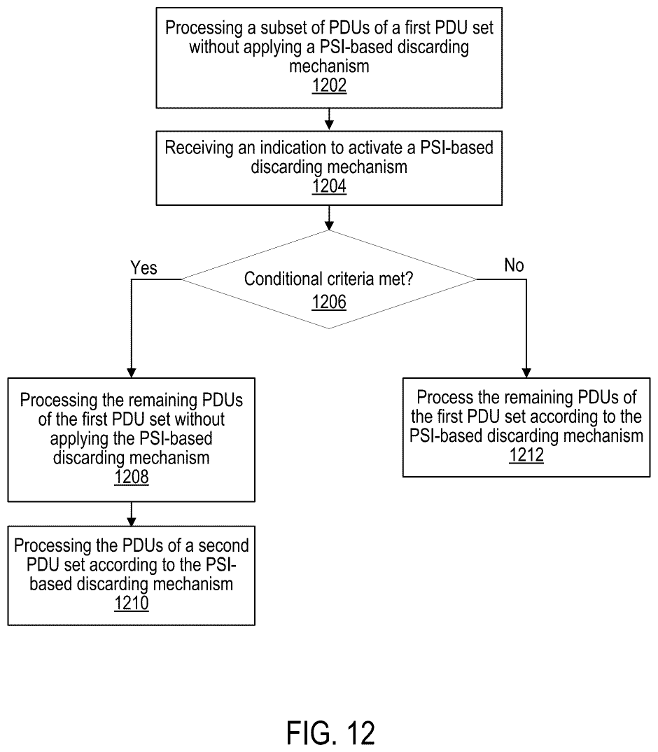

### FIGS. 10-11—Intra-PDU Set Behavior Switching

On some occasions, when the UE receives an indication to activate/enable a PSI-based discarding mechanism for a DRB when the UE has already started processing some (but not all) PDUs of a PDU set on the DRB, the UE may activate the PSI-based discarding mechanism in an intra-PDU set manner. Specifically, the UE may directly apply the PSI-based discarding mechanism on the remaining PDUs of the current PDU set, even if the mechanism has not been applied to earlier PDUs of the same PDU set.

For example, if the PSI-based discarding mechanism includes using different discard timer values for important and non-important PDU sets, the UE may directly use the discard timer value corresponding to the importance level of the PDU set for the remaining PDUs of the PDU set, even if a different discard timer value has been used for earlier PDUs of the same PDU set.

As another example, if the PSI-based discarding mechanism includes directly discarding non-important PDU sets, the UE may directly discard the remaining PDUs of the PDU set if this is a non-important PDU set. The UE may also directly discard the earlier PDUs of the same PDU set even if their discard timer(s) are still running. For instance, if the DRB is also configured to discard the whole PDU Set when at least one of the PDUs is lost/discarded (based on PSIHI).

FIG. 10 illustrates a flow chart of a method for activating a PSI-based discarding mechanism via intra-PDU set behavior, consistent with the preceding disclosure, according to some embodiments. The method may be performed by a UE, such as the UE 106, or by one or more components thereof, such as by the processor(s) 302 and/or the wireless communication circuitry 330 (e.g., by a baseband processor of the wireless communication circuitry 330 or of the cellular controller 354). It should be understood that the method of FIG. 10 may include additional elements beyond those shown.

As illustrated in FIG. 10, the UE 106 may, at 1002, process a subset of the PDUs of a first PDU set. Specifically, the UE 106 may, at this point, have processed (e.g., processed at least to the point of placing into a transmit buffer) some, but not all, of the PDUs of the first PDU set. The UE 106 may have processed the subset of the PDUs without a PSI-based discarding mechanism.

At 1004, the UE 106 may receive an indication to activate a PSI-based discarding mechanism. For example, the indication may be included in dedicated signaling from a wireless communication network with which the UE 106 is communicating. The signaling may be transmitted by a base station of the network, such as the base station 102. The signaling might be carried in an RRC message, a PDCP control PDU, a MAC CE, or other appropriate signal.

At 1006, the UE 106 may process the remaining PDUs of the first PDU set according to the PSI-based discarding mechanism. Specifically, the UE 106 may activate the PSI-based discarding mechanism before processing additional PDUs of the first PDU set.

Similarly, on some occasions, the UE may receive an indication to deactivate/disable a PSI-based discarding mechanism for a DRB when the UE has already started processing some (but not all) PDUs of a PDU set on this DRB. In some scenarios, the UE may refrain from applying the PSI-based discarding mechanism on the remaining PDUs of the PDU Set, even if such mechanism has been applied to earlier PDUs of the same PDU Set. The UE may instead apply default behaviors when processing the remaining PDUs of the PDU set, such as utilizing default discard timer values.

For example, if the PSI-based discarding mechanism includes using different discard timer values for important and non-important PDU sets, the UE may instead use the default discard timer value for the remaining PDUs of the current PDU set, even if a different discard timer value has been used for earlier PDUs of the same PDU set.

As another example, if the PSI-based discarding mechanism includes directly discarding non-important PDU sets, the UE may not directly discard the remaining PDUs of the PDU set if this is a non-important PDU set. However, if the DRB is also configured to discard the whole PDU set when at least one of the PDUs is lost/discarded (based on PSIHI), the UE may still directly discard the remaining PDUs of the PDU set, e.g., because the earlier PDUs may have already been discarded.

FIG. 11 illustrates a flow chart of a method for deactivating a PSI-based discarding mechanism via intra-PDU set behavior, consistent with the preceding disclosure, according to some embodiments. The method may be performed by a UE, such as the UE 106, or by one or more components thereof, such as by the processor(s) 302 and/or the wireless communication circuitry 330 (e.g., by a baseband processor of the wireless communication circuitry 330 or of the cellular controller 354). It should be understood that the method of FIG. 11 may include additional elements beyond those shown.

As illustrated in FIG. 11, the UE 106 may, at 1102, process a subset of the PDUs of a first PDU set. Specifically, the UE 106 may, at this point, have processed (e.g., processed at least to the point of placing into a transmit buffer) some, but not all, of the PDUs of the first PDU set. The UE 106 may have processed the subset of the PDUs according to a PSI-based discarding mechanism, such as any of the mechanisms disclosed herein.

At 1104, the UE 106 may receive an indication to deactivate a PSI-based discarding mechanism. For example, the indication may be included in dedicated signaling from a wireless communication network with which the UE 106 is communicating. The signaling may be transmitted by a base station of the network, such as the base station 102. The signaling might be carried in an RRC message, a PDCP control PDU, a MAC CE, or other appropriate signal.

At 1106, the UE 106 may process the remaining PDUs of the first PDU set without applying the PSI-based discarding mechanism. Specifically, the UE 106 may deactivate the PSI-based discarding mechanism before processing additional PDUs of the first PDU set.

Apart from activation/deactivation of PSI-based discarding mechanism, this same intra-PDU set behavior may, in some scenarios, be applied when the PDCP is re-configured while the UE is in the midst of a PDU set. For example, the UE may begin applying the new configuration immediately, in the current PDU set.

### FIG. 12—Conditional UE Behavior Determination

In some scenarios, inter-PDU set behavior and intra-PDU set behavior may each be used, based on various conditions.

As a first example, inter-PDU set behavior may be applied when the UE receives an indication to activate the PSI-based discarding mechanism while the UE is in the midst of processing a PDU set, but intra-PDU set behavior may be applied with the UE receives an indication to deactivate the PSI-based discarding mechanism while the UE is in the midst of processing a PDU set. The opposite arrangement is also possible, in which intra-PDU set behavior may be applied when the UE receives an indication to activate the PSI-based discarding mechanism while the UE is in the midst of processing a PDU set, but inter-PDU set behavior may be applied with the UE receives an indication to deactivate the PSI-based discarding mechanism while the UE is in the midst of processing a PDU set.

As a second example, the UE may apply either inter-PDU set behavior or intra-PDU set behavior based on how much time remains until expiry of a discard timer of the PDU set as a whole. E.g., if the remaining time is shorter than a predetermined threshold, then the UE may immediately apply the PSI-based discarding mechanism, according to intra-PDU set behavior. Because there is little time left before the current PDU set is discarded for failure to meet the PDU set discard timer, there is less risk of harm or inefficiency resulting from the PDU set being discarded as a result of immediate application of the PSI-based discarding mechanism.

As a third example, the UE may apply either inter-PDU set behavior or intra-PDU set behavior based on whether a portion (number, percentage, fraction, etc.) of PDUs of the current PDU set that has already been transmitted (or processed, discarded, etc.) meets a predetermined threshold. For example, if most of the PDUs of the current PDU set have already been transmitted, then the UE may apply inter-PDU set behavior, to avoid risk of discarding a nearly complete PDU set according to the PSI-based discarding mechanism. Inversely, if a relevant portion of the PDUs of the current PDU set have already been discarded, then the UE may apply the PSI-based discarding mechanism on the remaining PDUs in the same PDU set, according to intra-PDU set behavior, e.g., because successful communication of the PDU set is already degraded.

As a fourth example, the UE may apply either inter-PDU set behavior or intra-PDU set behavior based on whether the current PDU set is considered important or non-important. For example, if the current PDU set is identified as an important PDU set, then the UE may apply inter-PDU set behavior, to use the default discard timer for the remainder of the current PDU set. However, if the current PDU set is identified as a non-important PDU set, then the UE may apply intra-PDU set behavior, to activate the PSI-based discarding mechanism for the remainder of the current PDU set.

As a fifth example, the UE may apply either inter-PDU set behavior or intra-PDU set behavior based on whether the corresponding DRB is also configured to discard the whole PDU set when at least one PDU is lost/discarded (e.g., based on PSIHI). For example, if the UE is configured to discard the whole PDU set when at least one PDU is lost/discarded, then the UE may apply inter-PDU set behavior, so as to delay applying PSI-based discarding mechanism until the next PDU set, to avoid excessive discarding. However, if the UE is not configured to discard the whole PDU set when at least one PDU is lost/discarded, then the UE may apply intra-PDU set behavior.

As a sixth example, the UE may apply either inter-PDU set behavior or intra-PDU set behavior based on whether the overall buffer size of one or more Logical Channel (LCH) or LCH Group (LCG) satisfies a predetermined threshold. For example, if the buffer size already exceeds a predetermined threshold, then the UE may directly discard the PDUs of the PDU set, according to intra-PDU set behavior, to immediately alleviate congestion. However, if the overall buffer size of the applicable one or more LCH or LCG does not satisfy the predetermined threshold, then the UE may apply inter-PDU set behavior.

As a seventh example, the UE may apply either inter-PDU set behavior or intra-PDU set behavior based on an explicit indication in a configuration of the corresponding DRB. For example, a base station, such as the base station 102, may use a parameter in a message configuring the DRB, to explicitly instruct the UE to apply inter-PDU set behavior or intra-PDU set behavior when PSI-based discarding mechanism is activated on this DRB.

It should be understood that any appropriate combination of factors may be used, based on the preceding examples. For example, the UE may determine whether to apply inter-PDU set behavior or intra-PDU set behavior based on a combination of the time remaining until expiry of a PDU set discard timer and whether the DRB is also configured to discard the whole PDU set when at least one PDU is lost/discarded. For example, the threshold to be compared to the remaining time may be adjusted based on the DRB being configured to discard the whole PDU set. Other combinations are also envisioned.

FIG. 12 illustrates a flow chart of a method for activating a PSI-based discarding mechanism with conditional behavior criteria, consistent with the preceding disclosure, according to some embodiments. The method may be performed by a UE, such as the UE 106, or by one or more components thereof, such as by the processor(s) 302 and/or the wireless communication circuitry 330 (e.g., by a baseband processor of the wireless communication circuitry 330 or of the cellular controller 354). It should be understood that the method of FIG. 12 may include additional elements beyond those shown.

As illustrated in FIG. 12, the UE 106 may, at 1202, process a subset of the PDUs of a first PDU set. Specifically, the UE 106 may, at this point, have processed (e.g., processed at least to the point of placing into a transmit buffer) some, but not all, of the PDUs of the first PDU set. The UE 106 may have processed the subset of the PDUs without a PSI-based discarding mechanism.

At 1204, the UE 106 may receive an indication to activate a PSI-based discarding mechanism. For example, the indication may be included in dedicated signaling from a wireless communication network with which the UE 106 is communicating. The signaling may be transmitted by a base station of the network, such as the base station 102. The signaling might be carried in an RRC message, a PDCP control PDU, a MAC CE, or other appropriate signal.

At 1206, the UE 106 may evaluate whether one or more conditional criteria have been met. Such criteria may include any of the conditional criteria disclosed herein. For example, the UE 106 may determine whether the time remaining until expiry of a discard timer of the PDU set meets (or exceeds) a particular threshold. As another example, the UE 106 may determine whether a portion (e.g., number, percentage, fraction, etc.) of PDUs of the first PDU set that has already been processed meets (or exceeds) a particular threshold. As yet another example, the UE 106 may determine whether the first PDU set is identified as an important PDU set. Other examples may be easily formulated based on the various criteria disclosed above.

If the conditional criteria are met at 1206, then the UE 106 may proceed according to inter-PDU set behavior. Specifically, the UE 106 may, at 1208, process the remaining PDUs of the first PDU set without applying the PSI-based discarding mechanism. For example, the UE 106 may process the remaining PDUs in substantially the same manner as the previously processed subset of PDUs. Further, at 1210, the UE 106 may process the PDUs of a second PDU set according to the PSI-based discarding mechanism. Specifically, the UE 106 may activate the PSI-based discarding mechanism after completing the processing of the first PDU set, but before beginning processing of the second PDU set.

If the conditional criteria are not met at 1206, then the UE 106 may proceed according to intra-PDU set behavior. Specifically, the UE 106 may, at 1212, process the remaining PDUs of the first PDU set according to the PSI-based discarding mechanism. Specifically, the UE 106 may activate the PSI-based discarding mechanism before processing additional PDUs of the first PDU set.

It should be understood that, by utilizing various of the factors disclosed above, conditional criteria could be specified that would reverse the outcome of element 1206. For example, the UE 106 may determine whether a number (or percentage, fraction, etc.) of PDUs of the first PDU set has already been discarded meets (or exceeds) a particular threshold. In this case, if the conditional criteria are met at 1206, then the UE 106 may proceed according to intra-PDU set behavior, and the UE 106 may proceed according to inter-PDU set behavior if the conditional criteria are not met at 1206. This is merely a function of how the conditional criteria are formulated, and it should be understood that the most relevant factor is that the UE may decide to activate the PSI-based discarding mechanism according to either inter-PDU set behavior or intra-PDU set behavior based on one or more conditional criteria.

Similarly, a nearly identical flowchart could illustrate a scenario in which the UE 106 processes a subset of PDUs of the first PDU set according to the PSI-based discarding mechanism, and then receives an indication to deactivate the PSI-based discarding mechanism. In such a scenario, the US 106 may determine whether one or more conditional criteria are met, and may deactivate the PSI-based discarding mechanism according to either inter-PDU set behavior or intra-PDU set behavior based on one or more conditional criteria.

### Hybrid PSI-Based Discarding Mechanisms

As previously discussed, at least two options may be available as PSI-based discarding mechanisms. In the first option, the UE may apply different discarding timer values to important PDU sets and non-important PDU Sets. In the second option, the UE may continue to transmit important PDU sets as usual but may directly discard non-important PDU sets. Other options may also be available. In some scenarios, a PSI-based discarding mechanism may include a combination of options.

As a first example, when the UE receives an indication to activate the PSI-based discarding mechanism while the UE is in the midst of processing a PDU set, the UE may apply intra-PDU set behavior, utilizing two different mechanism options. For example, the UE may directly discard any non-important PDUs that have already arrived and queued in the buffer. However, for any PDUs arriving after the indication, the UE may not directly discard non-important PDUs, but may instead begin using different discard timer values for important and non-important PDU sets, even if a different discard timer value has been used for earlier PDUs of the same PDU set. This first example may be used in conjunction with any of the preceding scenarios in which intra-PDU set behavior is applied.

In some scenarios of the first example, the UE may directly discard non-important PDUs that have already arrived before the indication only if their “remaining time” falls below a predetermined threshold (the threshold being greater than zero). For example, a PDU may be discarded if its remaining time is less than the difference between the default discard timer value (e.g., the discard timer value used when the PSI-based discarding mechanism is not applied) and the discard timer value corresponding to non-important PDUs according to the PSI-based discarding mechanism, such that the PDU would have already been discarded if the discard timer value applied to non-important PDUs had been applied. Other threshold values are also envisioned.

As a second example, when the UE receives an indication to activate the PSI-based discarding mechanism while the UE is in the midst of processing a PDU set, the UE may directly discard the entire current PDU set, if the current PDU set is indicated to be a non-important PDU set. However, for subsequent PDU sets, the UE may not directly discard non-important PDUs, but may instead begin using different discard timer values for important and non-important PDU sets. This second example may be used in conjunction with any of the preceding scenarios in which intra-PDU set behavior is applied.

As in the first example, in some scenarios of the second example, the UE may directly discard non-important PDUs that have already arrived before the indication only if their “remaining time” falls below a threshold.

In some scenarios of the second example, if the current PDU set is an important PDU set, the UE may continue to use the default discard timer values for the remaining PDUs of the current PDU set, as in inter-PDU set behavior. In other scenarios of the second example, if the current PDU set is an important PDU set, then the UE may directly use the discard timer value corresponding to important PDUs according to the PSI-based discarding mechanism, as in intra-PDU set behavior.

As a third example, when the UE receives an indication to activate the PSI-based discarding mechanism while the UE is in the midst of processing a PDU set, the UE may determine whether it should apply the first option or the second option, based on whether PSIHI-based discarding is also configured for the corresponding DRB, or whether a second discard timer value (in addition to a default discard timer value) is configured. For example, in some scenarios, if PSIHI-based discarding is also configured, the UE may apply the second option, to directly discard all non-important PDU sets. This may be useful, e.g., if ensuring all PDUs are successfully delivered during high UL congestion is difficult. On the other hand, if PSIHI-based discarding is not configured, the UE may apply the first option, to continue attempting to transmit non-important PDU sets with a shorter discard timer. Alternatively, in some scenarios, the UE may apply the first option if PSIHI-based discarding is configured and may apply the second option if PSIHI-based discarding is not configured. Similarly, the UE may apply the first option if the second discard timer value is configured and may apply the second option if the second discard timer value is not configured. This third example may be used in conjunction with any of the preceding examples in which intra-PDU set behavior or inter-PDU set behavior is applied.

In the following, further example embodiments are provided.

A method may include: processing a subset of protocol data units (PDUs) of a first PDU set; receiving an indication from a wireless communication network to deactivate a PDU set importance (PSI)-based discarding mechanism; processing the remaining PDUs of the first PDU set according to the PSI-based discarding mechanism; and after processing the remaining PDUs of the first PDU set, processing PDUs of a second PDU set without applying the PSI-based discarding mechanism.

In some scenarios, the method may further include: after processing the second PDU set, processing a subset of PDUs of a third PDU set without applying the PSI-based discarding mechanism; receiving an indication from the wireless communication network to activate the PSI-based discarding mechanism; and processing the remaining PDUs of the third PDU set according to the PSI-based discarding mechanism.

In some scenarios, the PSI-based discarding mechanism includes using a first discarding timer value for PDU sets that are indicated by a PSI as important, and using a second, different discarding timer value for PDU sets that are indicated by a PSI as non-important.

In some scenarios, the PSI-based discarding mechanism includes discarding PDU sets that are indicated by a PSI as non-important, without attempting transmission.

In some scenarios, processing a PDU comprises loading the PDU into a transmit buffer.

A method may include: processing a subset of PDUs of a first PDU set; receiving an indication to deactivate a PSI-based discarding mechanism; determining whether specified conditional criteria are met; in response to determining that the specified conditional criteria are met, processing the remaining PDUs of the first PDU set according to the PSI-based discarding mechanism; and in response to determining that the specified conditional criteria hare not met, processing the remaining PDUs of the first PDU set without applying the PSI-based discarding mechanism.

In some scenarios, the method may further include: after processing the remaining PDUs of the first PDU set, processing PDUs of a second PDU set without applying the PSI-based discarding mechanism, regardless of whether the specified conditional criteria are met.

In some scenarios, determining whether the specified conditional criteria are met comprises determining whether a time remaining until expiry of a discard timer of the PDU set meets a particular threshold.

In some scenarios, determining whether the specified conditional criteria are met comprises determining whether a portion of PDUs of the first PDU set that has already been processed meets a particular threshold.

In some scenarios, determining whether the specified conditional criteria are met comprises determining whether the first PDU set is identified as an important PDU set.

In some scenarios, determining whether the specified conditional criteria are met comprises determining whether a buffer size of a logical channel (LCH) carrying the first PDU set is below a particular threshold.

A method may include: processing a subset of protocol data units (PDUs) of a first PDU set; receiving an indication from a wireless communication network to deactivate a PDU set importance (PSI)-based discarding mechanism; and processing the remaining PDUs of the first PDU set without applying the PSI-based discarding mechanism.

A device may include: one or more processors; and a memory having instructions stored thereon, which when executed by the one or more processors, perform steps of any of the preceding further example embodiments.

A non-transitory computer-readable storage medium may store software instructions, which, when executed by one or more processors, cause a wireless communication device to perform steps of any of the preceding further example embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
processing a subset of protocol data units (PDUs) of a first PDU set;
receiving an indication to activate a PDU set importance (PSI)-based discarding mechanism;
determining whether specified conditional criteria are met;
in response to determining that the specified conditional criteria are met, processing the remaining PDUs of the first PDU set without applying the PSI-based discarding mechanism; and
in response to determining that the specified conditional criteria have not met, processing the remaining PDUs of the first PDU set according to the PSI-based discarding mechanism.

2. The method of claim 1, further comprising:
after processing the remaining PDUs of the first PDU set, processing PDUs of a second PDU set according to the PSI-based discarding mechanism, regardless of whether the specified conditional criteria are met.

3. The method of claim 1, wherein determining whether the specified conditional criteria are met comprises determining whether a time remaining until expiry of a discard timer of the PDU set meets a particular threshold.

4. The method of claim 1, wherein determining whether the specified conditional criteria are met comprises determining whether a portion of PDUs of the first PDU set that has already been processed meets a particular threshold.

5. The method of claim 1, wherein determining whether the specified conditional criteria are met comprises determining whether the first PDU set is identified as an important PDU set.

6. The method of claim 1, wherein determining whether the specified conditional criteria are met comprises determining whether a buffer size of a logical channel (LCH) or a LCH group (LCG) carrying the first PDU set is below a particular threshold.

7. The method of claim 1, wherein the PSI-based discarding mechanism includes using a first discarding timer value for PDU sets that are indicated by a PSI as important, and using a second, different discarding timer value for PDU sets that are indicated by a PSI as non-important.

8. The method of claim 1, wherein the PSI-based discarding mechanism includes discarding PDU sets that are indicated by a PSI as non-important, without attempting transmission.

9. The method of claim 1, wherein processing a PDU comprises loading the PDU into a transmit buffer.

10. A device, comprising:
processor circuitry configured to:
process a subset of protocol data units (PDUs) of a first PDU set;
receive an indication from a wireless communication network to activate a PDU set importance (PSI)-based discarding mechanism; and
process the remaining PDUs of the first PDU set according to the PSI-based discarding mechanism.

11. The device of claim 10, wherein the PSI-based discarding mechanism includes:
in response to determining that a PSI associated with the first PDU set indicates that the first PDU set is non-important, discarding PDUs of the first PDU set that are queued in a transmit buffer prior to receiving the indication; and
for PDUs queued in the transmit buffer after receiving the indication, using a first discarding timer value for PDU sets that are indicated by an associated PSI as important, and using a second, different discarding timer value for PDU sets that are indicated by an associated PSI as non-important.

12. The device of claim 10, wherein the PSI-based discarding mechanism includes:
in response to determining that a PSI associated with the first PDU set indicates that the first PDU set is non-important, discarding the PDUs of the first PDU set; and
for PDUs of a second PDU set, arriving after the first PDU set, using a first discarding timer value if the second PDU set is indicated by a corresponding PSI as important, and using a second, different discarding timer value if the second PDU set is indicated by the corresponding PSI as non-important.

13. The device of claim 10, wherein the PSI-based discarding mechanism includes:
discarding a first PDU of the first PDU set in response to determining that a PSI associated with the first PDU set indicates that the first PDU set is non-important, and further in response to determining that a time remaining on a discard timer associated with the first PDU is below a particular threshold, wherein the threshold is greater than zero.

14. The device of claim 13, wherein the particular threshold constitutes a difference between a default discard timer value that is not associated with the PSI-based discarding mechanism and a discard timer value corresponding to non-important PSUs according to the PSI-based discarding mechanism.

15. The device of claim 10, further comprising:
in response to determining that a PSI associated with the first PDU set indicates that the first PDU set is important, using a discarding timer value that is specified for use with important PDU sets according to the PSI-based discarding mechanism when processing PDUs of the first PDU set that are queued after receiving the indication to activate the PSI-based discarding mechanism.

16. The device of claim 10, further comprising:
in response to determining that a PSI associated with the first PDU set indicates that the first PDU set is important, using a discarding timer value that is not associated with the PSI-based discarding mechanism when processing PDUs of the first PDU set that are queued after receiving the indication to activate the PSI-based discarding mechanism.

17. A non-transitory computer-readable storage medium storing instructions, which, when executed by one or more processors, cause a wireless communication device to:
process a subset of protocol data units (PDUs) of a first PDU set;
receive an indication from a wireless communication network to activate a PDU set importance (PSI)-based discarding mechanism;
process the remaining PDUs of the first PDU set without applying the PSI-based discarding mechanism; and
after processing the remaining PDUs of the first PDU set, process PDUs of a second PDU set according to the PSI-based discarding mechanism.

18. The non-transitory computer-readable storage medium of claim 17, wherein the instructions further cause the wireless communication device to:
after processing the second PDU set, process a subset of PDUs of a third PDU set according to the PSI-based discarding mechanism;
receive an indication from the wireless communication network to deactivate the PSI-based discarding mechanism; and
process the remaining PDUs of the third PDU set without applying the PSI-based discarding mechanism.

19. The non-transitory computer-readable storage medium of claim 17, wherein processing the remaining PDUs of the first PDU set without applying the PSI-based discarding mechanism is in response to determining that specified conditional criteria are met.

20. The non-transitory computer-readable storage medium of claim 19, wherein processing the PDUs of the second PDU set according to the PSI-based discarding mechanism is performed regardless of whether the specified conditional criteria are met.
